(19) United States
(12) Patent Application Publication
(10) Pub. No.: US 2005/0029818 A1
(43) Pub. Date: Feb. 10, 2005

(54) Hydroelectric machine

(76) Inventor: Nabil Frangie, Quebec (CA)

Correspondence Address: E Joseph Gess;Burns Doane Swecker & Mathis, P O Box 1404, Alexandria, VA, 22313-1404, US

(21) Appl. No.: 10/501,991

(22) PCT Filed: Jan. 21, 2002
(86) PCT No.: PCT/CA02/00066

(51) Int. Cl. H02P 9/04; F03B 13/00

(52) U.S. Cl. 290/54

(57) ABSTRACT

The invention relates to a hydroelectric machine. According to the invention, the machine comprises at least one arm which can rotate around an axle, said axle having a base which is disposed at the centre of a circular tank that is filled with water. Moreover, the aforementioned arm rests on the circular track which is formed by the upper surface of the external wall of said tank, by means of non-deforming wheels. Furthermore, said arm supports an assembly comprising a pump and, downstream, a turbine which is connected to the rotor of a first electric current generator. In addition, the above-mentioned arm is solidly connected to a first sheave wheel which is in turn connected to a second sheave wheel by means of a transmission belt, the axle of said second sheave wheel being solidly connected to the rotor of a second electric current generator.

The present invention relates to a hydroelectric machine.

The generation of electrical energy is subject to various constraints arising from the adverse effects of this generation. These constraints are due, on the one hand, to the long-term availability of energy obtained from fossil fuels and the pollution which their combustion causes, and, on the other hand, to the uncertain yield of the two main replacement energies, namely wind power and solar power, and, finally, to the safety problem and to the unpopularity of extending the use of nuclear energy.

The adverse effects, taken as a whole, of the generation of electrical energy has two important consequences: on the one hand, the investment volume grows increasingly and, on the other hand, the deterioration of the environment becomes more appreciable every day.

The object of the present invention is to provide an electric machine generating electrical energy without harmful effects for the environment and with relatively moderate installation and operating costs.

The machine according to the invention comprises:
at least one arm capable of rotating about a shaft, the shaft being located on a base at the center of a circular tank filled with water, the length of this arm being at least that for the radius of said tank,
said arm supporting an assembly comprising a pump and, downstream, a turbine connected to the rotor of a first electrical current generator,
said arm being secured with respect to a first grooved wheel, itself connected to a second grooved wheel of smaller diameter by means of a transmission belt,
the shaft of the second grooved wheel being secured with respect to the rotor of a second electrical current generator,
   in such a way, that when the machine is put into operation, two simultaneous effects occur: on the one hand, the water jet expelled by the pump toward the blades of the turbine drives the first generator via the latter in order to generate electrical current, and, on the other hand, the same jet gives rise to a reaction effect at its emergence from the pump and brings about the rotation of the arm and, thereby, the rotation of the first grooved wheel which, in turn, and by means of the transmission belt, causes the rotation of the second grooved wheel. The latter, since it is secured with respect to the rotor of the second electrical current generator, gives rise, by virtue of its own rotation, to that of this rotor, and the second generator itself also supplies electrical current.

The machine according to the invention thus recovers the effect of the expulsion of the water by a pump, and at high velocity, toward the blades of a turbine, twice: a first time as a result of the action of the jet striking the blades of the turbine and thus putting into operation the first electrical current generator, and a second time by utilizing the reaction effect generated by the jet emerging from the pump, said reaction effect causing the rotation of the two grooved wheels and consequently driving the second generator so that it, too, generates electrical current.

Advantageously, the assembly formed by the arm and the first grooved wheel is supported by nondeformable wheels intended for rotating along the circular track formed by the upper surface of the outer wall of the circular tank.

According to another characteristic of the invention, for feeding electrical energy to the pump, two conductive metallic rings are supported at the upper end of the rotary shaft of the arm, opposite two other respective conductive metallic rings carried by a nonconductive horizontal plane, itself supported by a structure independent of the machine, said metallic rings being connected, in particular, by means of conductive brushes or wipers.

According to yet another characteristic of the invention, in order to convey the electrical current generated by the first generator, two more other conductive metallic rings supported by the same horizontal plane confront two respective conductive metallic rings, said metallic rings being connected, in particular, by means of conductive brushes or wipers.

Moreover, the machine may comprise a certain number of arms, each carrying the assembly formed by the pump, the turbine and the generator.

The figures of the accompanying drawing will make it easy to understand how the invention can be implemented.

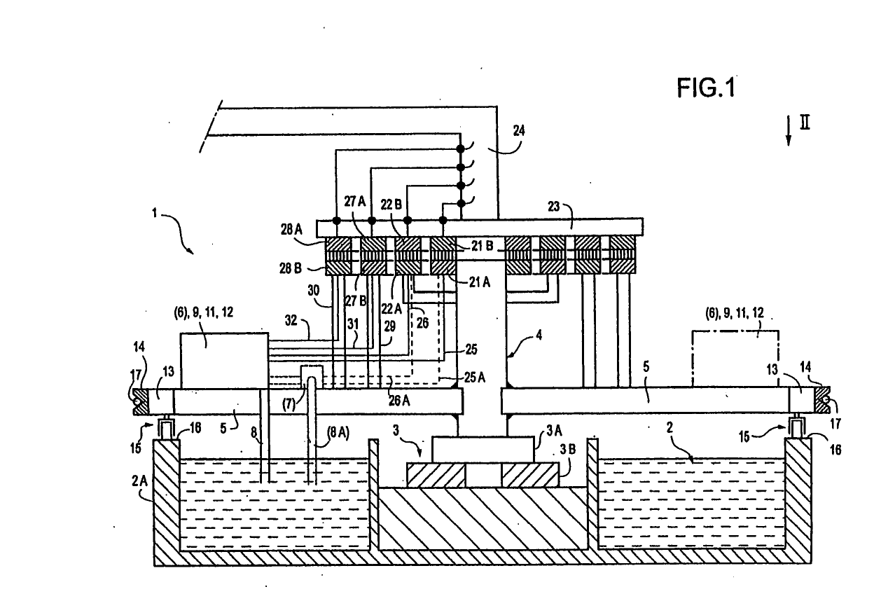

FIG. 1 is a diagrammatic sectional view of the machine according to the invention.

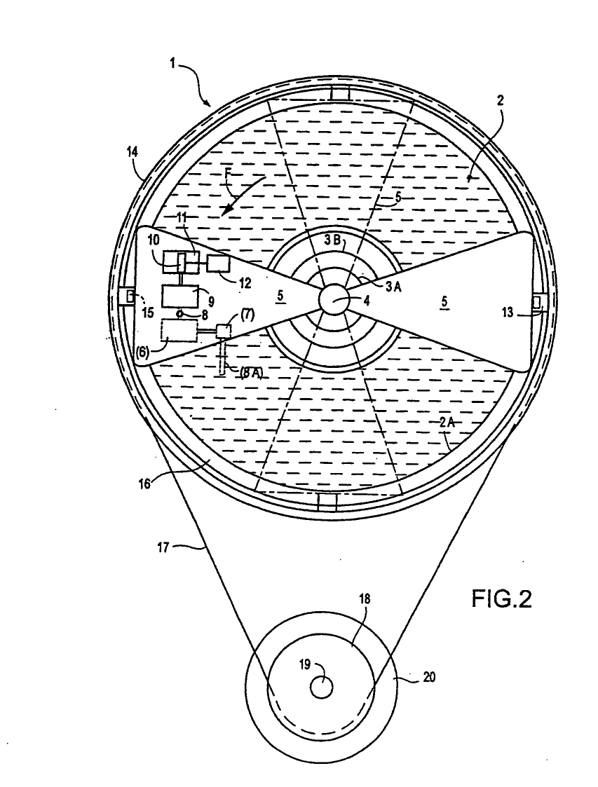

FIG. 2 is a top view of the machine according to the invention along the arrow II of FIG. 1.

The electric machine 1 according to the invention is formed as follows. At the center of a circular tank 2 filled with water, a base 3 is provided, on which a shaft 4 is mounted so as to be capable of rotating. The shaft 4 may rotate, for example, by means of a ball bearing (not shown) provided at the interface of the parts 3A and 3B of the base 3.

The shaft 4 carries, in the vicinity of its lower end, a certain number of horizontal arms 5 (at least one arm). This number may vary according to requirements, as illustrated by the fact that, in FIG. 2, two arms 5 are illustrated by unbroken lines and two others by broken lines.

On each arm 5, a pump 9 is provided, intended for expelling a water jet at high velocity toward the blades 10 of a turbine 11, the rotary shaft of the latter being secured with respect to the rotor of the first electrical current generator 12. The pump 9 is fed with water directly from the tank 2 by means of a pipe 8 which is immersed in this tank. The water sucked up and then expelled by the pump 9 toward the blades 10 of the turbine 11 falls back into the tank 2.

Furthermore, the end of each horizontal arm 5 carries a support 13, to which a grooved wheel 14 is fastened. The assembly formed by the arm 5, the support 13 and the grooved wheel 14 is supported by wheels 15 intended for rotating along the circular track 16 formed by the upper surface of the outer wall 2A of the tank 2. It will be noted that the wheels 15 are produced from a hard material, so as to prevent their deformation.

Moreover, the grooved wheel 14 carries a transmission belt 17 which passes via another grooved wheel 18 of smaller diameter, the shaft 19 of which is secured with respect to the rotor of the second electrical current generator 20 (FIG. 2).

In the machine according to the invention, the feed of water to the pump 9 takes place directly from the tank 2. The method whereby water is fed to the pump 9 may take place in various ways: either the pump 9 sucks up the water from the tank 2 by means of a pipe 8 or the pump 9 is connected to a water reservoir 6 fed by a second pump 7 which sucks up the water from the tank 2 by means of a pipe 8A. In this latter case, the pump 9 becomes the main pump and the pump 7 becomes a secondary pump. The choice between the two possibilities for feeding water to the pump 9 is made as a function of the installation constraints.

Still with regard to the choice of the second possibility for feeding water to the pump 9, that is to say that involving the use of the secondary pump 7 with the pipe 8A and of the reservoir 6, it should be noted that these three elements would be carried by the arm 5 at the rear of the main pump 9.

The main pump 9 is fed with electrical energy, for example, in the following way. At the upper end of the shaft 4, two conductive metallic rings 21A, 22A are supported, which are insulated from the shaft 4 and from their supports. Immediately above these rings 21A, 22A, are located two other conductive metallic rings 21B, 22B which are carried by a nonconductive horizontal plane, itself supported by a fixed structure 24 independent of the machine.

The connection between the conductive metallic rings 21A, 22A and 21B, 22B respectively may be obtained by means of conductive wipers (or conductive brushes), in such a way that the two polarities of the electrical current can be ensured and that the pump 9 can thus be fed with energy via the cables 25, 26 respectively.

Should the secondary pump 7 be used, it would be fed with electrical current along exactly the same path as that of the main pump 9. However, the secondary pump 7 would use separate electrical cables, to be precise the cables 25A and 26A (illustrated by broken lines in FIG. 1).

The conductive metallic rings 21B, 22B are connected to an electrical energy source external to the machine and not shown in FIGS. 1 and 2.

Similarly, two other concentric conductive metallic rings 27A, 28A are supported by the horizontal plane 23. They confront two other respective conductive rings 27B, 28B carried by insulating rods 29, 30 supported by the arm 5, thus making it possible, via the cables 31, 32, to convey the electrical current supplied by the first generator 12. The connection between said rings 27A, 28A and 27B, 28B respectively may likewise be obtained by means of conductive wipers (or conductive brushes), in order to ensure the transport of the electrical energy supplied by the generator 12 out of the machine.

The machine according to the invention operates as follows. By receiving the electrical current, the pump 9 sucks up water from the tank 2 and expels it at high velocity toward the blades 10 of the turbine 11. The action of the water jet which emerges from the pump 9 is twofold. On the one hand, it strikes the blades 10 of the turbine 11, and the latter, by virtue of its shaft secured with respect to the rotor of the first generator 12, drives this generator so as to generate electrical current; on the other hand, the same water jet expelled by the pump 9 brings about the rotation of the horizontal arm 5 about the shaft 4 (arrow F in FIG. 2). Since the arm 5 is secured with respect to the first grooved wheel 14, its rotation gives rise to that of said wheel, and then, since the latter is connected to the second grooved wheel 18 of smaller diameter by means of the transmission belt 18, the second grooved wheel 18 rotates in turn. Finally, since this second grooved wheel 18 is secured with respect to the shaft 19 of the rotor of a second electrical current generator 20, its rotation gives rise to that of the rotor and the second generator 20 likewise generates electrical current.

Finally, the overall generation of electrical current will be the sum of the generations of the two generators 12, 20, taking into account the losses, particularly in terms of the efficiency of the generators 12, 20; of the pump 9 (and, if appropriate, of the pump 7); of the turbine 11; of the two grooved wheels 14, 18; and, finally, of the friction of the supporting wheels 15.

1. An electric machine, wherein it comprises:
at least one arm capable of rotating about a shaft, this shaft having a base, at the center of a circular tank filled with water,
said arm supporting an assembly comprising a pump and, downstream, a turbine connected to the rotor of a first electrical current generator, and
said arm being secured with respect to a first grooved wheel, itself connected to a second grooved wheel by means of a transmission belt,
the shaft of the second grooved wheel being secured with respect to the rotor of a second electrical current generator,
the pump sucking up the water from the tank by means of a pipe, in such a way that, on the one hand, water jet expelled by the pump toward the blades of the turbine drives the first generator via the latter in order to generate electrical current, and, on the other hand, the same water jet brings about the rotation of the arm and, thereby, that of the first grooved wheel and thus, by means of the transmission belt, that of the second grooved wheel, thus driving the second generator so as to generate electrical current.

2. The machine as claimed in claim 1, wherein the assembly comprising the pump, of the turbine and of the first electrical current generator may, as required, comprise a second pump feeding a reservoir connected to the pump, the second pump sucking up the water from the tank by means of a pipe.

3. The machine as claimed in claim 1, wherein the arm first grooved wheel assembly is supported by wheels intended for rotating along a circular track formed by the upper surface of the outer wall of the tank.

4. The machine as claimed in claim 2, wherein, for feeding electrical energy to the pump, two conductive metallic rings are supported at the upper end of the rotary shaft of the arm, opposite two other respective conductive metallic rings carried by a nonconductive horizontal plane, itself supported by a structure independent of the machine, said metallic rings being connected, in particular, by means of conductive brushes or wipers.

5. The machine as claimed in claim 4, wherein, in order to convey the electrical current supplied by the first generator, two more other conductive metallic rings supported by the horizontal plane confront two respective conductive metallic rings, said metallic rings being connected, in particular, by means of conductive brushes or wipers.

6. The machine as claimed in claim 1, wherein it comprises a certain number of arms, each carrying the assembly comprising the pump, the turbine and the generator, this assembly being capable of being completed by a secondary pump feeding a reservoir connected to the pump and sucking up the water from the tank by means of a pipe.

7. The machine as claimed in claim 2, wherein it comprises a certain number of arms, each carrying the assembly comprising the pump, the turbine and the generator, this assembly being capable of being completed by a secondary pump feeding a reservoir connected to the pump and sucking up the water from the tank by means of a pipe.

8. The machine as claimed in claim 3, wherein it comprises a certain number of arms, each carrying the assembly comprising the pump, the turbine and the generator, this assembly being capable of being completed by a secondary pump feeding a reservoir connected to the pump and sucking up the water from the tank by means of a pipe.

9. The machine as claimed in claim 4, wherein it comprises a certain number of arms, each carrying the assembly comprising the pump, the turbine and the generator, this assembly being capable of being completed by a secondary pump feeding a reservoir connected to the pump and sucking up the water from the tank by means of a pipe.

10. The machine as claimed in claim 5, wherein it comprises a certain number of arms, each carrying the assembly comprising the pump, the turbine and the generator, this assembly being capable of being completed by a secondary pump feeding a reservoir connected to the pump and sucking up the water from the tank by means of a pipe.
